(19) United States
(12) Patent Application Publication
(10) Pub. No.: US 2004/0217337 A1
(43) Pub. Date: Nov. 4, 2004

(54) Curable resinous compositions for forming soft, abrasion-resistant coating compositons for fabrics

(76) Inventor: John W. Andrews, Madison, CT (US)

Correspondence Address: PERMAN & GREEN, 425 POST ROAD, FAIRFIELD, CT, 06824, US

(21) Appl. No.: 10/425,150

(22) Filed: Apr. 29, 2003

(51) Int. Cl. F21V 9/00

(52) U.S. Cl. 252/582

(57) ABSTRACT

An aqueous polymeric composition for applying prints or coatings to soft, pliable fabrics and curing them to produce aesthetic prints or coatings which are resistant to removal by abrasion and which also maintain the softness and pliability of the fabric. The present composition comprises a curable water-soluble polymer binder material(s) comprising acrylic ester groups and urethane groups, preferably a plurality of glass microspheres in a weight equal to at least 50% by weight of the polymeric binder materials(s), and a water soluble curing agent. The composition forms an insoluble, abrasion-resistant light-reflective and/or light-refractive print, or coating on the fabric upon evaporation of water and curing of the polymeric binder materials.

### BACKGROUND OF THE INVENTION

The present invention relates to heat-curable resinous compositions preferably containing microparticles, such as small glass microspheres and other light-enhancing particles, for forming soft, abrasion-resistant, light-refractive and/or light-reflective coatings on substrates such as garment fabrics, automobile headliner fabrics and other fabric substrates on which light-reflective or light-refractive abrasive-resistant surface coatings are desirable to enhance the appearance and to impart high-visibility for safety, aesthetic and other purposes.

1. Field of the Invention

The inclusion of microspheres, both clear and metallized, in heat-curable resinous coating compositions is well known in the art, including automotive paint compositions and screen printing ink compositions for fabrics.

2. State of the Art

Reference is made to commonly-owned U.S. Pat. No. 6,242,056 (Spencer et al.) which discloses aesthetic, light-refracting resinous microsphere coating compositions. Water-based compositions based upon water-soluble, curable resinous binder materials such as acrylic ester resins or polyurethane polyester resins are disclosed. Reference is also made to U.S. Pat. No. 5,650,213 (Rizika et al.) for its disclosure of aesthetic, retroreflective screen printing inks containing microspheres for the decorative printing of fabrics such as garments, without interfering with flexibility, crock or launderability. The use of water is disclosed as a volatile vehicle or dispersant for the resinous non-volatile matrix material which may include an acrylic copolymer.

Reference is also made to U.S. Pat. No. 4,263,345 (Bingham) which discloses coating compositions for making fabrics brightly retroreflective at nighttime, comprising aqueous compositions including acrylic-based polymers, or polyurethanes, and up to about 34% by volume of the solids content of transparent glass microspheres having an average diameter less than 100 microns, i.e., between 21 and 63 microns. The coating compositions are applied to tightly-woven nylon oxford fabric as thin layers providing low densities of microspheres, and heat cured to form a continuous layer of binder material with microspheres distributed over the surface of the fabric. The coated fabric is said to handle and feel about the same as it did before coating, i.e., supple and flexible.

However, an unattractive fabric “hand” results because the glass content is large relative to the amount of binder present. For example, the ratio of glass to binder can be as high as 4 to 1. The glass spheres present can be either clear or can be hemispherically coated with aluminum. Two problems that result with low bead content are poor aesthetics and poor reflective characteristics. A problem that results with high bead content is that there may be a lack of softness as well as abrasion resistant due to the low binder present. The invention solves these problems.

### SUMMARY OF THE INVENTION

The present invention is based upon the discovery of novel curable polymeric binder materials for providing exceptionally soft, flexible coatings for fabrics, which preferably contain large volumes of glass microspheres and which bind such microspheres in and on the fabric against removal under the effects of strong abrasion. The present curable polymeric binder materials comprise a) mixtures of water-soluble acrylic acid ester polymers, including copolymers, and up to about 20% by weight of urethane polymers, or b) acrylic polyurethane polymers formed by reacting polyacrylic alcohols such as diols with aliphatic polyisocyanates.

The present invention relates to improved curable fabric-coating compositions containing glass microspheres, preferably glass spheres having an average diameter up to about 20 microns, and cross-linkable resinous binder materials. This invention also relates to methods for producing curable coating compositions which contain high loads of glass microsphere particles that are more tightly bonded within the composition, resulting in compositions having improved bonding properties for substrates.

The present invention is concerned with both improving the adhesion and the abrasion resistant properties of the coating and films formed that are applied over textiles. It is understood that such improvements also improve the coated or printed underlying text by giving a protective abrasion resistant coating or film on the surface of the textile. The incorporation of glass microspheres is for two purposes. Hemispherically aluminum-coated or silver-coated glass spheres will give retroreflection of light. The use of clear glass spheres promotes light transmission through the coating, thus enhancing the resulting aesthetic effects. The composition of said film includes micro particles such as the mentioned glass spheres, glass flakes, mica and similar pigment as well as color enhancing materials within the fabric coating composition. The invention improves the abrasion resistant properties of the fabric. High loads of glass spheres, up to 400% of the weight of the polymeric binder are possible, and yet the softness and flexibility are not sacrificed. The beneficial properties of aluminized as well as the clear glass spheres can thus be optimized without sacrificing tactile properties. Automotive as well as safety apparel fabrics are two of the many applications.

### DETAILED DESCRIPTION

Example 1 illustrates the preparation of a suitable water-soluble acrylic acid ester/acrylic acid co-polymer for use according to the present invention in association with a water-soluble polyester polyurethane or a water-soluble polyether polyurethane to provide a polymeric binder material capable of binding a large load of small glass microspheres, greater than 50% by weight and up to 400% by weight of the binder material in a polymeric coating in which the microspheres are so tightly bound that they resist being removed under the effects of strong abrasion.

### EXAMPLE 1

| Monomer | moles |
|---|---|
| Methylmethacrylate | 10 |
| Butyl methacrylate | 10 |
| Acrylic acid | 2 |
| Catalyst polymer initiator | 1 |
| (Isopropylpercarbonate | |
| or benzyl peroxide) | |
| Phosphate emulsifier surfactant | 2% |
| Water | 60% |

The above composition is subjected to conventional emulsion polymerization conditions to produce a water-soluble MMA/BMA/AA copolymer which, even with a suitable crosslinking agent such as aziridine or a polycarbodiimide, by itself, is not capable of sustaining a large load of micro size glass, over 50% and up to 300% by weight of the binder material, and provide abrasion resistance.

The use of a soft acrylic polymer coating with a suitable crosslinking agent (polycarbodiimide) provides softness as well as optical clarity. An acrylic polymer based on methyl methacrylate monomer with a small amount of acrylic acid gives the clarity as well as the softness required. Increased softness is provided by replacing the methyl ester group with larger alkyl groups such as propyl and butyl groups. A blend then of the following acrylic monomers, methyl methacrylate, butyl methacrylate and propyl methacrylate, with 5 to 10% acrylic acid, provides a water soluble acrylic ester polymer having suitable properties of softness and optical clarity. The monomers are polymerized in situ (in water) using a peroxide initiator such as benzoic peroxide. Isopropyl percarbonate is another peroxide used where optical clarity is desired.

The acrylic polymer alone, even with a suitable crosslinking agent such as aziridine, a polycarbodiimide, polyisocyanate or melamine is not capable of sustaining a large load of micro size glass, over 50% by weight, and maintaining integrity after abrasion and repeated washing of the resulting fabric such that the beads will not fall out and that the coating or print will have abrasion resistance.

The abrasion resistance is achieved by the addition, to the acrylic polymer, of a water-soluble polyurethane polymer in small amounts not to exceed 20% by weight. The polyurethane polymer has to be chosen to give compatibility to the acrylic polymer as well as be optically transmissive. Polyurethanes are based on preexisting polymers such as polyesters and polyethers. They also are based on either aromatic or aliphatic isocyanates. For the application of optically transmitting polymers however aliphatic isocyanates are preferred as they do not yellow as the aromatic variety do.

For polyester-based polyurethane components, the reaction products of aliphatic diols and saturated dibasic acids give enhanced optical clarity such as the choice of tetra phthalic and iso phthalic acid as well as hexahydro phthalic and iso phthalic acids. The diols of butane and hexane are preferred.

The preferred polyether polurethanes are the water soluble reaction products of aliphatic polyethers such as polypropylene ether and polytetramethylene ether with polyisocyanates such as aromatic diisocyanates or, preferably, aliphatic diisocyanates such as isophorone diisocyanate, which are clearer in color than the yellowish aromatic type.

The present polyurethane polymer compositions also preferably contain dimethyl propionic acid (DMPA) which serves two important functions. First, it provides water solubility in association with a tertiary amine such as triethyl amine (TFE). Secondly, the pendant carboxyl group reacts with the curing agents to facilitate the curing mechanism, binding the polymer(s) and encapsulating the glass beads in a tight matrix.

The following Example 2 illustrates the preparation of a preferred polyether polyurethane for use in an amount up to 20% by weight, based upon the total weight of the binder material of the present compositions, i.e., in combination with at least 80% by weight of the water-soluble acrylic polymer.

### EXAMPLE 2

### 2 Polyether-Based Polyurethane

| Material | Parts by Wt. | Mol. Wt. | Moles | Equivalents | ratio |
|---|---|---|---|---|---|
| Polytetra | 100 | 2000 | .05 | 1 | 1.0 |
| methylene | | | | | |
| ether | | | | | |
| Isophorone | 25.25 | 202 | .125 | .25 | 2.5 |
| Diisocyanate | | | | | |
| Dimethyol | 3.7 | 148 | .025 | .05 | .5 |
| Propionic Acid | | | | | |
| (DMPA) | | | | | |
| Isophorone | 6.57 | 146 | .045 | .09 | .9 |
| Diiamine | | | | | |
| Triethylamine | 2.52 | 101 | .025 | .025 | .25 |
| (TEA) | | | | | |

The polyurethane in Example 2 is technically a polyurea since diamines are used to chain-extend the urethane prepolymer (react with the diisocyanates). The DMPA allows the urethane to go into water solution. Amines are preferred to react with aliphatic diisocyanates in commercial applications as they give good film tensile properties whereas the use of diols, typical in aromatic urethane usage, would not.

Isophorone diamine is used as the chain extension agent since an aliphatic diisocyanate(s) must be used when diamines are used as the chain extending agents.

Polyethers such as polytetramethylene oxide are used because they will not hydrolyze or break down in the presence of water or moisture. This increases the washability compared to polyester-based polyurethanes. Also they are resistant to fungus and mildew.

As discussed above, the formed aqueous polyurethane comprises a polyurea formed by the reaction of the diamine, which functions as a chain extending agent, with the isophorone diisocyanate(s). The dimethylol propionic acid assists in the curing or crosslinking of the polyurethane by reaction with pendant carboxyl groups.

Examples 3, 4 and 5 illustrate a composition comprising a mixture of the acrylic copolymer binder material of Example 1 and the polyether and polyester polyurethanes of Example 2 and a large content of glass microspheres having an average diameter between about 10-18μ, together with a polycarbodiimide curing agent.

### EXAMPLE 3

| Material | dry Weight |
|---|---|
| Acrylic formula 1 | 100 |
| Polyurethane Formula 2 | 10 to 20 |
| Glass Microspheres | 100 to 200 |
| (10μ average size) | |
| Polycarbodiimide | 20 to 40 |

Example 4

| | | | Ratio dry | |
|---|---|---|---|---|
| Materials | Wet weight | Dry weight | wt. | Trade name |
| Acrylic resin | 6.08 | .4864 | 1.0 | LF412 |
| Ailphatic | .3476 | .121 | .248 | Ru40-512 |
| urethane | | | | |
| Aluminized | | 1.46 | 3.00 | P2453BTA |
| glass beads | | | | |
| Clear glass | | .36 | .740 | P2415BT |
| beads (10μ | | | | |
| size) | | | | |
| Ionic | .30 | .075 | .154 | LF411 |
| thickening | | | | |
| agent | | | | |
| Carbodiimide | .06 | .30 | .616 | XR 5570 |
| curing agent* | | | | |
| *replaces | .3 | .30 | .616 | XR 2500 |
| aziridine | | | | |

The above formula provides a very soft hand. The addition of up to 20 percent urethane provides the abrasion resistance. The limits of the urethane that are effective for abrasion resistance can be as low as 12.5% of the weight of the acrylic where exceptional softness, “hand” is desired. This is the case for headliner fabrics.

In the case of purely aesthetic coatings, where retroreflectivity is not an objective, the aluminized glass is replaced with the clear Barium titanate glass and soda glass. A formula is given below:

EXAMPLE 5

| | Wet | Dry | | Trade |
|---|---|---|---|---|
| Materials | weight | weight | Ratio | name |
| 1. acrylic resin | 6.08 | .4864 | 1.0 | LF412 |
| 2. aliphatic | .1738 | .0605 | .124 | RU40-512 |
| urethane | | | | |
| 3. Barium | | 1.0 | 2.05 | P2415BT |
| titanite glass | | | | |
| spheres (10 to | | | | |
| 18 micron | | | | |
| average) | | | | |
| 4. soda glass | | 1.0 | 2.05 | P2015SL |
| spheres | | | | |
| micron | | | | |
| 5. ionic | .3 | .075 | .154 | LF411 |
| thickener | | | | |
| 6. carbodiimide | .6 | .30 | .616 | XR 5290 |
| curing agent | | | | |

The amount and ratios of P2415BT to P2015SL glass used depends on gloss levels and color matching desired. The P2015SL glass shifts the color to a darker hue in the light spectrum.

The ratios of glass are important factors in achieving certain colors and three dimensional effects. The present invention is more concerned with the resin binder materials than the glass. However, the use of glass makes the entire composition work for the transmission of light, the effect of color matching, and softness with abrasion resistance. The use of clear glass with two different refractive indexes gives a three dimensional depth to the coating.

It is very unusual to have such a high glass load and not stiffen the coated substrate. The use of the acrylic resin gives the exceptional softness.

The usual acrylic resin is made from methyl acrolein (acrylic aldehyde) and some acrylic acid, polymerized in an emulsion using peroxide free radicals. The small amount of acrylic acid provides water solubility.

An alternative binder material to the mixture of the water-soluble acrylic acid ester polymer and the water soluble polyether polyurethane or polyester polyurethane polymeric binder material is a water soluble acrylic diol polyurethane polymer, which also has been found to be capable of strongly bonding large amounts of glass microbeads in fabric coatings, and providing abrasion-resistance while leaving the fabric as soft and pliable as it was before coating and yet imparting beautiful light-refracting and color-enhancing properties to fabrics useful in the garment, upholstery, window-dressing and automotive fields. The acrylic diol aliphatic diisocyanate based polymers provide enhanced optical and physical properties. The ratios of acrylic diol can be adjusted to give high optical transmission. The use of diisocyanate in different ratios (stoichiometry) controls the softness and hardness of the polymer used to carry the glass microspheres. Such coatings provide enhanced optical properties, as an alternative to a mixture of an acrylic polymer and a polyurethane polymer. Dimethylol propionic acid (DMPA) is included in small amounts to improve water solubility, and as a curing and crosslinking agent which reacts with pendant carboxyl groups of the acrylic polyurethane polymer. Additional crosslinking agents such as aziridines, polycarbodiimides and water-soluble aliphatic diisocyanates can also be used.

The following Examples 6 and 7 illustrate the preparation of water-soluble polyacrylic diol polyurethane polymer binder materials for use according to the present invention.

| Material | Parts by Wt. | Mol. Wt. | Moles | Equivalents | ratio |
|---|---|---|---|---|---|
| Polyacrylic | 100 | 2000 | .05 | .01 | 1.0 |
| diol | | | | | |
| Isophorone | 25.25 | 202 | .125 | .25 | 2.5 |
| Diisocyanate | | | | | |
| Dimethylol | 3.7 | 148 | .025 | .05 | .5 |
| Propionic Acid | | | | | |
| (DMPA) | | | | | |
| Isophorone | 6.57 | 146 | .045 | .09 | .9 |
| Diiamine | | | | | |
| TEA | 2.52 | 101 | .025 | .025 | .25 |

The composition of Example 6 above produces a soft coating. Increasing the weight of the polyol will require less of the diisocyanate. This decreases the stiffness or the modulus of the polymer as opposed to lower molecular weight materials. Another technique is to vary the ratio of the isocyanate to the hydroxyl groups. This however means the amount of chain extender to be used, whether diol or amine, will vary. It is easier to vary the molecular weight of the polyacrylic diol, whereby a harder coating is produced to provide an increase of abrasion resistance.

### EXAMPLE 7

| Material | Parts by Wt. | Mol. Wt. | Moles | Equivalents | ratio |
|---|---|---|---|---|---|
| Polyacrylic | 100 | 1000 | .1 | .2 | 1.0 |
| diol | | | | | |
| Isophorane | 40.4 | 202 | .2 | .4 | 2.0 |
| Diisocyanate | | | | | |
| (IPDI) | | | | | |
| Dimethyol | 2.96 | 148 | .02 | 04 | .2 |
| Propionic Acid | | | | | |
| (DMPA) | | | | | |
| Isophorone | 10.95 | 146 | .075 | .15 | .75 |
| Diamine | | | | | |
| TEA | 7.57 | 101 | .075 | .075 | .375 |

By adjusting the molar ratio of isocyanate to the molar ratio of the hydroxyl present on the acrylic polymer it is seen that the hardness can be either increased or decreased. This is accomplished by going from a 2000 molecular weight polyether to a 1000 molecular weight polyether as seen in the difference in formula between Examples 7 and 8. The ratio of isocyanate to polyol increases as the molecular weight of the polyol decreases. In Example 7, the ratio was changed from 2.5 to 2.0 since the use of 2.5 with a 1000 MW/polyol would result in too hard a polymer.

Thus, adjustment of the molecular weight of polyol and changing the ratios of polyol to isocyanate result in a useful technique to control hardness.

This is a better method than using mixtures of the polyurethane and the acrylic in Examples 4 and 5 above.

Isophorone diisocyanate is used as an aliphatic diisocyanate since it is easy to work with and not overly toxic.

Other commercial diisocyanates that are aliphatic are (4,4, bis cyclohexyl methylene diisocyanate) by Dow Chemical Co., and TDX by Allied Chemical.

The following Example 8 illustrates the polyacrylic polyurethane composition of Example 7 used as a polymeric binder material for a large content of glass microbeads to provide an aesthetic coating composition for soft pliable fabrics such as nylon, while retaining the softness and pliability of the fabric.

### EXAMPLE 8

| | Wet | | Ratio dry |
|---|---|---|---|
| Material | Weight | Dry weight | weights |
| PAU resin* | 100 | 35 | 1.0 |
| Barium | — | 35 | 1.0 |
| titanate | | | |
| Glass spheres | | | |
| Clear | | | |
| 18μ) | | | |
| Soda glass | — | 35 | 1.0 |
| spheres | | | |
| Polycarbodiimide | 21.00 | 10.5 | 0.3 |

*Polyacrylic urethane polymer of Example 7.

The aqueous coating is coated or printed onto the surface of a soft, pliable fabric such as a thin nylon or cotton/polyester blend fabric and heated to cure the polymer binder material and evaporate the water vehicle to form a thin abrasion-resistant aesthetic surface layer which is light-refractive.

The coating includes two types of glass beads. One is clear and the other is aluminized for retroreflectance.

The addition of mixtures of clear glass microspheres of the same or different refractive indexes, within the range of about 1.7 and 2.5, more preferably between about 1.9 and 2.1, in various ratios refracts the light throughout the coating. The sum of the many refractions is in effect a transmission of light throughout the coating. The intensity of the color is increased. This results in a darker shade or hue. The word magnifying has been used for this effect. When other colored additives such as mica, pigments and dyes are used, the colors are refracted and mixed. The refracted light leaves the coating at the surface, exiting at all angles between 0 and 180 degrees when viewed. This omnidirectional view allows the same color intensity when viewed from any direction.

In summary, the use of glass microspheres in fabric coatings or prints dramatically improves the aesthetic look and the attractiveness of fabrics, while preserving the softness and feel. The application of a coating containing glass microspheres to automobile headliner fabric dramatically improves the visual aspects by reflecting and transmitting light.

In prior known coating systems, the high load or content of glass microbeads that is required to achieve these effects make the underlying fabric stiff and rigid. Stiffness is an unsatisfactory characteristics in automotive, as well as apparel, fabrics.

The present invention employs a water based acrylic ester or acrylic urethane polymer as the main resin component or binder of the glass beads. The acrylic is used because its light transmission of 99% does not interfere with the light transmission of the glass beads. The aesthetic properties are thus preserved by using the acrylic polymer.

The acrylic ester polymer by itself, however, is not strong enough to hold the up to 400% weight load of glass. The 400% represents a 4 to 1 ratio of the glass to acrylic polymer. The addition of up to 20 percent of a water based polyurethane that has carboxyl groups attached to it allows a very tough polymer to be formed but one, with the acrylic, that does not increase the stiffness of the fabric such coating is applied to. The use of the aliphatic urethane gives the highest transmission of light, about 90 percent compared to the much lower value, 75% provided by other, aromatic based polyurethanes. The reflectivity does not work well with aromatic based polyurethanes. Aromatic urethane use requires much higher loads of clear or aluminized glass to approach effects provided by aliphatic polyurethanes.

The inclusion of curatives that react with the carboxyl groups on both the acrylic and polyurethane allows a tough but soft film to be formed. There are four main crosslinking agents. Aziridine and carbodiimide react primarily with the pendant carboxyl groups. Melamine resins react with any active hydrogen whether carboxyl, urea, or urethane hydrogen. The diisocyanates will also react with the same active hydrogen as the melamines. In the case of melamine resins an acidic catalyst is used such as para toluene sulphonic acid. This acid is typically buffered with a tertiary amine that is volatile at processing temperatures present in the drying ovens. Once the amine volatizes, the catalyst becomes active and causes the melamine to react. A disadvantage of the melamine aldehyde resins is the release of formaldehyde which has a threshold of 1 part per million in the work place. Recent regulations and concerns about formaldehyde curtail the use of these melamine resins.

Polycarbodiimide has replaced the aziridines where the conditions are not available to incinerate the fumes or to handle such a reactive crosslinker as the aziridines.

A fourth novel crosslinker is an aliphatic polyisocyanate such as the adduct of dimethylol propionic acid (DMPA) and isophorone diisocyanate (IPDI). When emulsified and added to water, the material has a long shelf life since the aliphatic isocyanate is resistant to reacting with the water. Ordinary aromatic diisocyanates will react immediately with water. This material, the DMPA adduct, is also relatively non toxic, being dispersed in water. Use of this crosslinker with the water based polyurethane and poly acrylic resins gives the advantage of an environmentally safe as well as a non toxic coating.

The adduct of dimethylol propionic acid and isophorone diisocyanate is used because the carboxyl group present can be ionized by addition of an amine and thus the adduct is water soluble. The slowness of reacting with water of the aliphatic isocyanate present allows suitable pot life once the said curative is added to the glass and particular resin chosen. The curative is environmentally friendly.

An additional technique is to add a tertiary amine such as polycat 41 from Air Products. This technique is used in rigid urethane foams to produce cyanurate or trimerization of the free isocyanate. However the trimerization of isocyanate produces a matrix with a high crosslink density that further entraps or holds large weights of glass beads present in the composition.

The use of the coating systems thus described provides abrasion resistance to the coated fabric. This phenomenon of a high load of glass and soft coating providing abrasion resistance is unexpected. This feature, providing softness and abrasion resistance at the same time is unique.

The following example 9 shows a formulation using the trimerization catalyst as well as the DMPA/IPDI adduct.

### EXAMPLE 9

| Material | Wet Weight | Dry weight | Ratio dry weight |
|---|---|---|---|
| PAU resin* | 100 | 35 | 1.0 |
| Barium | | 35 | 1.0 |
| Titanate | | | |
| Glass spheres | | | |
| Soda glass | | 35 | 1.0 |
| Spheres | | | |
| DMPA/IPDI | 42 | 21 | .6 |
| Polycat 41 | .1 to .2 | .1 to .2 | .003 to .006 |

Also one can use Desmodur W (Dow Chemical) and TDX (Allied Chemical) as aliphatic diisocyanates in place of IDPI to react with DMPA. The following formula illustrates preparing the IPDI/DMPA adduct.

### EXAMPLE 10

### Formula for DMPA/IPDI Adduct

| Material | Wt. | M. Wt. | Moles | Equivalents | Ratio equivalents |
|---|---|---|---|---|---|
| DMPA | 35.59 | 148 | .24 | .481 | 1.0 |
| IPDI | 100 | 208 | .481 | .962 | 2.0 |
| TEA | 48.58 | 101 | .481 | .481 | 1.0 |

The two to one isocyanate to hydroxyl ratio allows the free isocyanate to be available to react with the coating system as well as be available to be trimerized by a tertiary amine catalyst. The Triethyl Amine (TEA) ionizes the carboxyl group thus allowing the adduct to be water soluble.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An aqueous polymeric composition for applying light refractive prints or coatings to soft, pliable fabrics and curing them to produce aesthetic prints or coatings which are resistant to removal by abrasion and which maintain the softness and pliability of the fabric, said composition comprising a curable water-soluble polymer binder material(s) comprising acrylic ester groups and urethane groups, a plurality of glass microspheres in a weight equal to at least 50% by weight of the polymeric binder materials(s), and a water soluble curing agent, said composition being capable of forming an insoluble, abrasion-resistant light-refractive print, or coating on said fabric upon evaporation of water and curing of said polymeric binder materials.

2. A composition according to claim 1 in which the curable water soluble binder material(s) are selected from the group consisting of acrylic ester-urethane copolymers and mixtures of acrylic ester polymers and up to 20% by weight of urethane polymers.

3. A composition according to claim 2 in which the acrylic ester comprises an aliphatic ester having from 2 to 6 carbon atoms in the aliphatic group.

4. A composition according to claim 1 in which the glass microspheres have an average diameter

5. A composition according to claim in which the glass microspheres comprise a mixture of clear glass spheres and glass spheres which are hemispherically-metallized.

6. A composition according to claim 1 which further comprises additional light-enhancing colored pigments, dyes, mica particles or colored glass beads.

7. A composition according to claim 1 in which the glass bead content is equal to at least 100% by weight of the polymeric binder material.

8. A composition according to claim 7 in which the glass bead content is up to 400% by weight of the polymeric binder material.

9. A composition according to claim 1 in which the glass microspheres are all hemispherically-metallized beads.

10. A composition according to claim 1 in which the glass microspheres comprise a mixture of spheres having different refractive indexes within the range of about and

11. An aqueous polymeric composition for applying prints or coatings to soft, pliable fabrics and curing them to produce prints or coatings which are resistant to removal by abrasion and which maintain the softness and pliability of the fabric, said composition comprising a curable water-soluble polymer binder material(s) comprising acrylic ester groups and urethane groups, and a water soluble curing agent, said composition being capable of forming an insoluble, abrasion-resistant print or coating on said fabric upon evaporation of water and curing of said polymeric binder materials.

12. A composition according to claim 11 in which the curable water soluble binder material(s) are selected from the group consisting of acrylic ester-urethane copolymers and mixtures of acrylic ester polymers and up to 20% by weight of urethane polymers.

13. A composition according to claim 12 in which the acrylic ester comprises an aliphatic ester having from 2 to 6 carbon atoms in the aliphatic group.
